(19) United States
(12) Patent Application Publication
(10) Pub. No.: US 2007/0091201 A1
(43) Pub. Date: Apr. 26, 2007

(54) Displayed image capturing method and system

(75) Inventor: Hiroshi Sasaki, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/387,661

(22) Filed: May 15, 2006

(30) Foreign Application Priority Data
Oct. 26, 2005 (JP) 2005-310,846

(51) Int. Cl. G03B 7/00; H04N 5/235

(52) U.S. Cl. 348/362

(57) ABSTRACT

A method for capturing displayed images periodically renewed and displayed on a display device, by a global-shutter type capturing device. Prior to actual capturing of the displayed images, a predetermined image is displayed on the display device and captured N-times (N>2) by the capturing device with a predetermined capturing period, and over an exposure time selected from a predetermined search range. Among the N captured images, there are calculated N−1 sum values or average values of differences between a specified image and remaining images at their predetermined regions. A flicker amplitude evaluation value is calculated based on a deviation of the sum values or the average values. A flickerless exposure time is calculated based on at least two exposure times, which are the minimal values among the flicker amplitude evaluation values corresponding to a plurality of exposure times within the search range. The exposure time of the capturing device is controlled based on the calculated flickerless exposure time, for actually capturing the displayed image of the display device.

### TECHNICAL FIELD

The present invention relates to a method and a system for capturing displayed images which are displayed on an image display device.

### RELATED ART

An image display device in the form of a multi-projection system is known, wherein a plurality of images are projected from corresponding projectors, and synthesized and displayed on a screen. In such a multi-projection system, for example, it is necessary to ensure that the difference in color and/or luminance between the images projected form the respective projectors, and the seams between the adjacent images are made as less noticeable as possible.

Therefore, the applicant has proposed an image display device wherein a calibration image is projected onto a screen, the projected image is captured by a capturing means, such as a digital camera or the like, and various calibrations are performed based on the captured image. An image display device of this type is disclosed, for example, in Japanese Patent Application Laid-open Publication Nos. 2002-72359 and 2002-116500.

With the image display device disclosed in these patent documents, the captured calibration image is used to measure the relative spatial relationship between the screen and the plurality of projectors, the difference in color or luminance between the images projected from the respective projectors, and shading in color or luminance within a projector, to calculate geometrical calibration parameters and color calibration parameters, and to perform an image calibration based on the calculated parameters, thereby allowing a seamless image with high resolution and high definition, to be projected onto a large screen.

As the projectors used for such an image display device, for example, there is known a single panel type projector using a single panel of display element, and a three panel type projector using three panels of display element.

In the case of a single panel type projector, for example, a color wheel is arranged between a white light source and the single panel of display element in the form of a spatial light modulator, such as a digital micromirror device (DMD) or a liquid crystal, wherein the color wheel is provided with color filters allowing transmission of at least three primary colors (red, green and blue). The color wheel is rotated at a predetermined frequency (e.g., 240 Hz) while controlling the modulation intensity of each pixel of the display element synchronously with the rotation of the color wheel so as to sequentially display the respective primary color images. Since human visual sense recognizes an integral image focused on the retina over a predetermined time length, it is possible for the observer to recognize a full color displayed image in which three primary color images are synthesized, by setting the sequential displaying period to be faster than the predetermined time length (integral time).

A three panel type projector includes display elements for modulating the respective three primary color lights, wherein the three modulated lights which have been modulated by the respective display elements are projected after being synthesized by a cross prism or the like. Unlike a single panel type projector, a three panel type projector does not include a color wheel, though it allows a motion image to be displayed by switching the modulated images of the display elements with a predetermined frequency (e.g., 60 Hz).

Furthermore, for capturing a calibration image upon calibration of the image display device, there are known digital cameras including a CMOS device or a CCD device.

A digital camera using a CMOS device is less expensive, though it generally adopts a rolling shutter system. In this instance, for example, when an image is captured with a predetermined exposure time, the exposure of each of the capturing lines, which are arranged in a vertical direction, does not begin simultaneously. Rather, the capturing is performed with the capturing starting time shifted from the uppermost capturing line to the lowermost capturing line. Therefore, even though this would not be a problem when the capturing object is still, if the capturing object is moving, then a distorted image would be captured due to the shifting of the capturing starting time for each capturing line depending upon the moving speed of the object.

On the other hand, in the case of a digital camera including a CCD device, a global shutter system is generally adopted, wherein the capturing within an entire capturing area begins simultaneously, without giving rise to distortion of the image depending upon the moving speed of the object to be captured. However, when a displayed image of the image display device, which is periodically renewed, is to be captured, there would occur problems associated with the global shutter system.

The problem associated with the global shutter system will be explained below with reference to FIGS. 12(a) to 12(c) and 13(a) and 13(b), assuming that the image display device includes a single panel type projector, by way of example.

It is further assumed that, as shown in FIG. 12(a), the single panel type projector includes a color wheel 1201 which is rotated at a frequency a Hz, to display a uniform white image on a screen. In this instance, only over a duration in which each of the R (red), G (green), B (blue) and W (white) filters constituting the color wheel 1201 is aligned with the optical path of the white light source, only the light of the color corresponding to each filter illuminates the screen. Thus, as shown by graph 1202 of FIG. 12(b), which illustrates the relationship between the screen illuminance and time, the screen illuminance is divided into regions R, G, B and W in a time-shared manner, with a period β msec where β=1/α.

Further assuming that a uniform red (R) image only is displayed, by way of example, and for the sake of simplicity, the lights of colors other than red are shielded, so that the relationship between the screen illuminance and time is as shown by graph 1203 in FIG. 12(c), with the same period β msec of the red (R) light as in the previous graph 1202.

FIGS. 13(a) and 13(b) are graphs wherein the graph 1203 of FIG. 12(c) is added with the exposure time during which the CCD device is exposed. Here, the exposure times from the capturing starting timings f0, f1, f2 and f3 are illustrated as hatched regions 1301, 1302, 1305 and 1306. It can be seen how many periods R with higher screen illuminance can be accommodated in each area. Also illustrated are captured images 1303, 1304, 1307 and 1308 which are obtained as a result of integration of the hatched regions 1301, 1302, 1305 and 1306. FIGS. 13(a) and (b) are different from each other in terms of the exposure time of the CCD device. To be more specific, FIG. 13(a) shows a case wherein the exposure time γ msec is not integer times β msec (i.e., γmsec≠β×n msec), whereas FIG. 13(b) shows an opposite case wherein the exposure time γ msec is integer times β msec (e.g., γ msec=2β msec).

In the case of FIG. 13(a), since the exposure time is not integer times β msec, even though the exposure times at different capturing timings are the same, the number of R is 2 in the region 1301 and 1 in the region 1302, which are different from each other. Thus, the integral values are different from each other such that the captured image 1303 is twice brighter than the captured image 1304. This means that the brightness of the captured image fluctuates depending upon the capturing timing.

On the other hand, in the case of FIG. 13(b), since the exposure time is integer times β msec, the number of R included in the regions 1305 and 1306 at different capturing timings is both 2, with the result that both captured images 1307 and 1308 exhibit the same level of brightness. The same applies to any capturing timings, provided that the area of R and the period β msec are accurate.

It can be appreciated from the foregoing explanation that, when the displayed image of the periodically driven image display device is to be captured by a digital camera, such as a CCD device, an exposure time matched with the display renewal period must be selected.

Now, defining the above phenomenon as “flicker”, a further detailed explanation will be given below as to why the flicker occurs.

Assuming that the display period of the displayed image by the image display device is represented as β, the capturing period of the capturing device as γ and the exposure time as T, their relationships are represented as δ=nβ±δ and T=mβ±ε, where δ represents an error between the display period and the capturing period, which is expressed as 0≦δ≦β/2, ε represents an error between the exposure time and the display period, which is expressed as 0≦ε≦β/2, and m and n are both integers of not less than 1. Namely, there is considered a case where an ordinary capturing device is used in which the capturing period γ is longer than the display period β.

The flicker period Fp under such conditions can be expressed as Fp=Mβ/γ where M is the least common multiple of δ and β. Here, the domain of γ is [0, β/2] so that the flicker period Fp can be expressed as 2β≦Fp≦∞. Further, the flicker amplitude Fa increases as ε increases. Thus, the condition in which flicker does not occur is either δ=0 or ε=0.

The condition δ=0 means that the display period β and the capturing period γ have an integer times relationship to each other, with the result that all the capturing timings have the same phase without causing flickers (i.e., flicker period is infinite). Furthermore, the condition ε=0 means that the exposure time T is integer times the display period β, corresponding to the case explained with reference to FIG. 13(b), with the result that the flicker amplitude Fa=0 without causing flickers.

Therefore, in order to satisfy at least the condition δ=0, the display period of the display device and the capturing period of the capturing device must be synchronized with each other. To this end, it is know to synchronize the display device and the capturing device through a synchronizing signal, as disclosed in Japanese Patent Application Laid-open Publication No. 11-184,445, for example.

In the capturing method disclosed in Japanese Patent Application Laid-open Publication No. 11-184,445, upon capturing the displayed images of the display device by a camera, a shutter control signal is generated in response to a vertical synchronizing signal of the display device, and the shutter of the camera is controlled by the shutter control signal so that the starting and ending timings of the capturing by the camera are synchronized with the starting and ending timings of the rendering by the display device, in order to obtain captured image data which is free from mixture of the crossband. Namely, the solution disclosed in this patent document satisfies the two conditions δ=0 and ε=0, by a synchronizing signal.

Furthermore, there is also known a capturing device which adopts a rolling shutter system as in the CMOS device, instead of the global shutter system, and which satisfies the condition ε=0, as disclosed in Japanese Patent Application Laid-open Publication No. 07-336,586, for example.

In the capturing method disclosed in Japanese Patent Application Laid-open Publication No. 07-336,586, upon capturing of an object by a capturing device of a line sensor driving type, a frequency analysis is performed by detecting a change in illumination light of the object, and the integer times the period of the most frequent frequency component is set as the exposure time of the line sensor so as to mitigate the influence of the change in illumination light of the object.

When the displayed images periodically renewed by an image display device such as the above-mentioned multi-projection system are to be captured by a digital camera adopting a global shutter system, such as a CCD device, not only the exposure time matched with the renewal period (display period) of the displayed image must be accurately determined, but also it is necessary to ensure that the digital camera can be arranged at any desired location sufficiently spaced from the screen, in order to capture the entirety of the image projected onto the screen all at once.

However, in the capturing method disclosed in Japanese Patent Application Laid-open Publication No. 11-184,445, although it is possible to accurately adapt the exposure time to the image display device, the image display device and the capturing device must be connected to each other by a cable for transmitting the synchronizing signal, making it difficult to arrange the capturing device at a desired position sufficiently spaced from the screen.

Furthermore, in the capturing method disclosed in Japanese Patent Application Laid-open Publication No. 07-336,586, since the change in illumination light of the object is subjected to a frequency analysis, and the integer times the period of the most frequent frequency component is set as the exposure time, it is possible to calculate the exposure time by using the crossbar that occurs in the rolling shutter system, though this method cannot be applied to a global shutter system wherein crossbar does not occur in the captured image.

### DISCLOSURE OF THE INVENTION

Therefore, it is an object of the present invention to provide displayed image capturing method and system, wherein periodically renewed displayed images of the image display device can be captured by a global shutter type capturing device, without using a synchronizing signal, from any desired position, while effectively suppressing occurrence of flickers.

To this end, a first aspect of the present invention resides in a displayed image capturing method for capturing displayed images by a global-shutter type image capturing device, said displayed images being periodically displayed on an image display device, comprising:
displaying, prior to actual capturing of said displayed images, a predetermined image on said image display device and capturing said predetermined image N-times (N>2) by said image capturing device with a predetermined capturing period, and over an exposure time selected from a predetermined search range, so as to obtain N captured images;
calculating, among said N captured images, N−1 sum values or average values of differences between a specified image and remaining images at their predetermined regions, and obtaining a flicker amplitude evaluation value based on a deviation of said sum values or of said average values;
calculating a flickerless exposure time based on at least two exposure times which are minimal values among said flicker amplitude evaluation values corresponding to a plurality of exposure times within said search range; and
subsequently controlling the exposure time of said image capturing device based on the calculated flickerless exposure time, so as to actually capture the displayed image of said image display device.

According to the first aspect of the present invention, it is possible to effectively suppress the fluctuation in brightness due to the flicker that occurs in the captured image of the displayed image, while achieving a high freedom degree as to the position of the capturing device relative to the image display device.

A second aspect of the present invention resides in the displayed image capturing method according to the first aspect, which further comprises: capturing said predetermined image M-times (M>2) within a predetermined period determined by said predetermined capturing period; calculating a time variation period of an average luminance at a predetermined region of the M captured images; and calculating the number of times N of capturing said predetermined image based on said time variation period of the average luminance.

According to the second aspect of the present invention, since the flicker amplitude evaluation value can be calculated within a minimum required time and with high accuracy, while achieving a high freedom degree as to the position of the capturing device relative to the image display device, it is possible to accurately calculate the flickerless exposure time, which serves as the basis for more effectively suppress the fluctuation in brightness due to the flicker that occurs in the captured image of the displayed image.

A third aspect of the present invention resides in a displayed image capturing method for capturing displayed images by a global-shutter type image capturing device, said displayed images being periodically displayed on an image display device, comprising:
displaying, prior to actual capturing of said displayed images, a predetermined image on said image display device and capturing said predetermined image N-times (N>2) by said image capturing device with a predetermined capturing period, and over an exposure time selected from a predetermined search range, so as to obtain N captured images;
calculating, among said N captured images, N−1 sum values or average values of absolute values of differences between a specified image and remaining images at a predetermined region, or N−1 sum values or average values of said differences to an even power, and obtaining a flicker amplitude evaluation value based on a deviation of said sum values or of said average values;
calculating a flickerless exposure time based on at least two exposure times which are minimal values among said flicker amplitude evaluation values corresponding to a plurality of exposure times within said search range; and
subsequently controlling the exposure time of said image capturing device based on the calculated flickerless exposure time, so as to actually capture the displayed image of said image display device.

According to the third aspect of the present invention, it is possible to effectively suppress the fluctuation in brightness due to the flicker that occurs in the captured image obtained from the displayed image of the unsynchronized multi-display device, while achieving a high freedom degree as to the position of the capturing device relative to the image display device.

A fourth aspect of the present invention resides in the displayed image capturing method according to the third aspect, which further comprises: capturing said predetermined image M-times (M>2) within a predetermined period that is determined by said predetermined capturing period; calculating, among the M captured images of said predetermined image, M−1 sum values or average values of absolute values of differences between a specified image and remaining images at a predetermined region, or M−1 sum values or average values of said differences to an even power, and calculating the number of times N of capturing said predetermined image based on a time variation period of the M−1 calculated values.

According to the fourth aspect of the present invention, since the flicker amplitude evaluation value can be calculated within a minimum required time and with high accuracy, while achieving a high freedom degree as to the position of the capturing device relative to the image display device, it is possible to accurately calculate the flickerless exposure time, which serves as the basis for more effectively suppress the fluctuation in brightness due to the flicker that occurs in the displayed image of the unsynchronized multi-display device.

A fifth aspect of the present invention resides in the displayed image capturing method according to the first or third aspect, wherein said at least two exposure times for calculating said flickerless exposure time are exposure times with which said flicker amplitude evaluation values become minimal values, and with which deviation of said flicker amplitude evaluation values becomes not lower than a predetermined threshold value, with respect to a plurality of exposure times within said search range, including said exposure times which are said minimal values.

According to the fifth aspect of the present invention, since an erroneous detection of the required minimal values of the flicker amplitude evaluation value can be mitigated, while achieving a high freedom degree as to the position of the capturing device relative to the image display device, it is possible to accurately calculate the flickerless exposure time, which serves as the basis for more effectively suppress the fluctuation in brightness due to the flicker that occurs in the captured image of the displayed image.

A sixth aspect of the present invention resides in a displayed image capturing system for capturing displayed images by a global-shutter type image capturing device, said displayed images being periodically displayed on an image display device, comprising:
capturing control means for controlling said image capturing device so as to capture a predetermined image, which is displayed on said image display device, N-times (N>2) with a predetermined capturing period, and over an exposure time selected from a predetermined search range;
flicker amplitude evaluation value calculating means for calculating a flicker amplitude evaluation value by calculating, among said N captured images, N−1 sum values or average values of differences between a specified image and remaining images at their predetermined regions, and obtaining a deviation of said sum values or of said average values as a basis for calculation of the flicker amplitude evaluation value; and
flickerless exposure time calculating means for calculating a flickerless exposure time based on at least two exposure times which are minimal values among said flicker amplitude evaluation values corresponding to a plurality of exposure times within said search range.

According to the sixth aspect of the present invention, it is possible to achieve the advantageous functions as in the first aspect, with a simple arrangement of the system which comprises (i) capturing control means for controlling said image capturing device so as to capture a predetermined image, which is displayed on said image display device, N-times with a predetermined capturing period, and over an exposure time selected from a predetermined search range, (ii) flicker amplitude evaluation value calculating means for calculating a flicker amplitude evaluation value based on N captured images obtained by the N times capturing, and (iii) flickerless exposure time calculating means for calculating a flickerless exposure time based on the calculated flicker amplitude evaluation values.

A seventh aspect of the present invention resides in the displayed image capturing system according to claim 6, which further comprises flicker period calculating means for calculating the number of times N of capturing said predetermined image based on a time variation period of an average luminance at a predetermined region of M captured images (M>2) obtained by capturing said predetermined image M-times within a predetermined period determined by said predetermined capturing period.

According to the seventh aspect of the present invention, it is possible to achieve the advantageous functions as in the second aspect, with a simple arrangement of the system which further comprises flicker period calculating means for calculating the number of times N of capturing the predetermined image based on a time variation period of an average luminance at a predetermined region of the captured images.

An eighth aspect of the present invention resides in a displayed image capturing system for capturing displayed images by a global-shutter type image capturing device, said displayed images being periodically displayed on an image display device, comprising:
capturing control means for controlling said image capturing device so as to capture a predetermined image, which is displayed on said image display device, N-times (N>2) with a predetermined capturing period, and over an exposure time selected from a predetermined search range;
flicker amplitude evaluation value calculating means for calculating a flicker amplitude evaluation value by calculating, among said N captured images, N−1 sum values or average values of absolute values of differences between a specified image and remaining images at a predetermined region, or N−1 sum values or average values of said differences to an even power, and obtaining a deviation of said sum values or of said average values as a basis for calculation of the flicker amplitude evaluation value; and
flickerless exposure time calculating means for calculating a flickerless exposure time based on at least two exposure times which are minimal values among said flicker amplitude evaluation values corresponding to a plurality of exposure times within said search range.

According to the eighth aspect of the present invention, it is possible to achieve the advantageous functions as in the third aspect, with a simple arrangement of the system which comprises (i) capturing control means for controlling said image capturing device so as to capture a predetermined image, which is displayed on said image display device, N-times with a predetermined capturing period, and over an exposure time selected from a predetermined search range, (ii) flicker amplitude evaluation value calculating means for calculating a flicker amplitude evaluation value based on N captured images obtained by the N times capturing, and (iii) flickerless exposure time calculating means for calculating a flickerless exposure time based on the calculated flicker amplitude evaluation values.

A ninth aspect of the present invention resides in the displayed image capturing system according to the eighth aspect, which further comprises flicker period calculating means for calculating the number of times N of capturing the predetermined image based on a time variation period of M−1 calculated values (M>2) obtained by capturing said predetermined image M-times within a predetermined period determined by said predetermined capturing period, and calculated, among the M captured images of said predetermined image, as M−1 sum values or average values of absolute values of differences between a specified image and remaining images at a predetermined region, or M−1 sum values or average values of said differences to an even power.

According to the ninth aspect of the present invention, it is possible to achieve the advantageous functions as in the fourth aspect, with a simple arrangement of the system which further comprises flicker period calculating means for calculating the number of times N of the capturing based on a time variation period relating to the sum values the absolute values of the differences between the images at a predetermined region, sum values of such differences to an even power.

A tenth aspect of the present invention resides in the displayed image capturing system according to the sixth or eighth aspect, wherein said flickerless exposure time calculating means comprises means for determining whether or not the deviation of the flicker amplitude evaluation values within said predetermined exposure time search range, including said flicker amplitude evaluation values that become the minimal values, is not lower than a predetermined threshold value.

According to the tenth aspect of the present invention, it is possible to achieve the advantageous functions as in the fifth aspect, with a simple arrangement of the system in which the flickerless exposure time calculating means comprises means for determining whether or not the deviation of the flicker amplitude evaluation values within the predetermined exposure time search range is not lower than a predetermined threshold value.

In the displayed image capturing system according to the sixth or eighth aspect, the capturing control means may serve to control the exposure time of the image capturing device based on the calculated flickerless exposure time, for actually capturing the displayed image of the image display device.

### BRIEF DESCRIPTION OF THE DRAWINGS

The present invention will be described below in further detail, with reference to the preferred embodiments shown in the accompanying drawings.

FIG. 1 is a schematic view showing a multi-projection system incorporating an image capturing system according to a first embodiment of the present invention.

FIG. 2 is a perspective view showing an arrangement of the image capturing camera in FIG. 1.

FIG. 3 is a block diagram showing a functional arrangement of the camera control section.

FIGS. 4 and 5 are graphs each schematically showing the relationship between the exposure time for capturing an image by a global shutter type capturing device and the change in brightness which occurs in the captured image.

FIGS. 6 to 8 are graphs showing the process for calculating synchronized exposure time.

FIGS. 9(a) to 9(c) are schematic diagrams showing the flicker that occurs in the captured image obtained by a multi-projection system according to a second embodiment of the present invention.

FIG. 10 is a flowchart showing the processing steps of the exposure control in the multi-projection system of the second embodiment.

FIG. 11 is a flowchart showing the processing steps for calculating calibration data multi-projection system according to

FIGS. 12(a) and 12(b) are schematic view showing a sequential color display in a single panel type projector, useful for explaining the above-mentioned conventional technology.

FIGS. 13(a) to 13(c) are schematic diagrams showing the relationship between the sequential color display in a single panel type projector and the image capturing time with a global shutter type capturing device, and further showing the flicker that occurs in the captured image, also useful for explaining the above-mentioned conventional technology.

### DETAILED EXPLANATION OF THE PREFERRED EMBODIMENTS

### First Embodiment

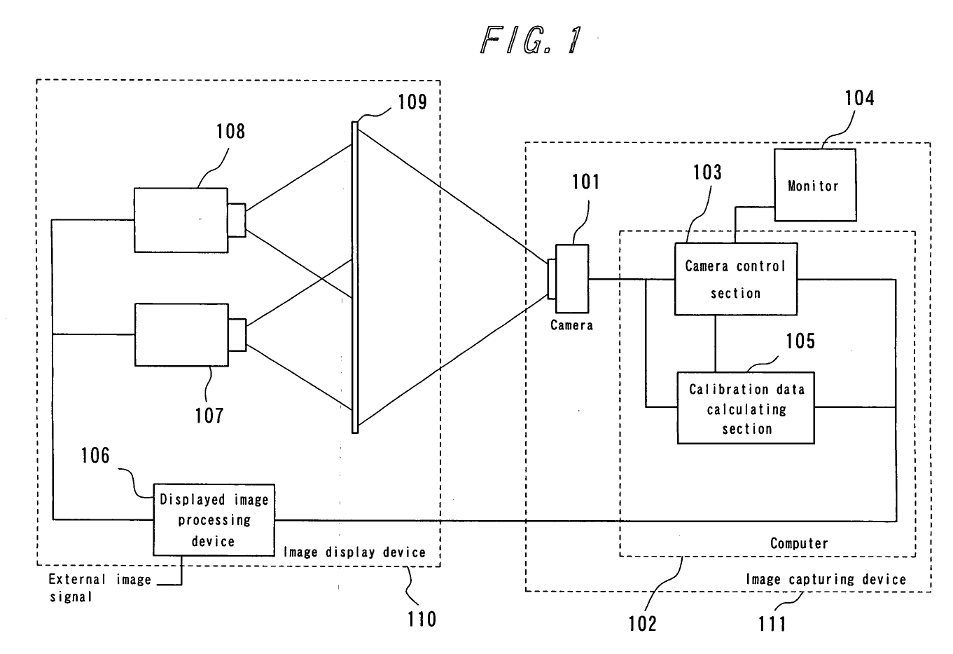

Referring to FIG. 1, there is shown a multi-projection system incorporating an image capturing system 111 according to a first embodiment of the present invention, wherein images displayed by an image display device 110 is captured by the capturing system 111. The image display device 110is in the form of a rear projector type multi-projection system comprising two projectors 107, 108 which are driven synchronously by an external synchronizing means, a displayed image processing device 106 for controlling the displayed image, such as distribution of the image to the two projectors 107, 108, and a screen 109 for displaying images projected from the projectors 107, 108.

The image capturing system 111 comprises a camera 101 for capturing the displayed image on the screen 109, a monitor 104 for monitoring the captured image, and a computer 102 with a camera control section 103 for controlling the exposure time of the camera, etc., and a calibration data calculating section 105 which calculates the calibration data for calibrating the difference in color between the projectors, geometrical distortion of the projected images, etc., based on the captured image.

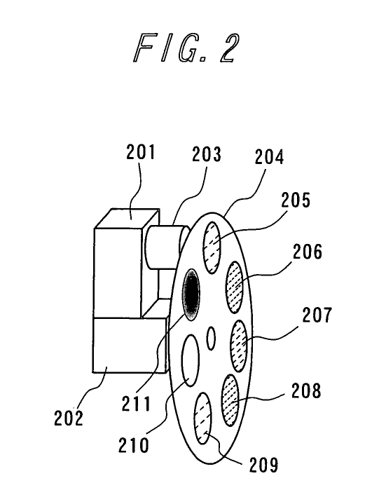

The camera 101 comprises, as schematically shown in FIG. 2, a capturing section 201 including a CCD device and its driver circuit, a capturing lens 203, a turret 204 and a driving motor 202 for the turret 204. The turret 204 holds color filters 205, 206, 207 having tristimulus values X, Y and Z, ND filters 208, 209 having different densities, a through-hole 210, and a light shielding disc 211, which are arranged in concentric manner. The turret 204 is driven into rotation by the driving motor 202 so as to bring each filter in alignment with the lens 203.

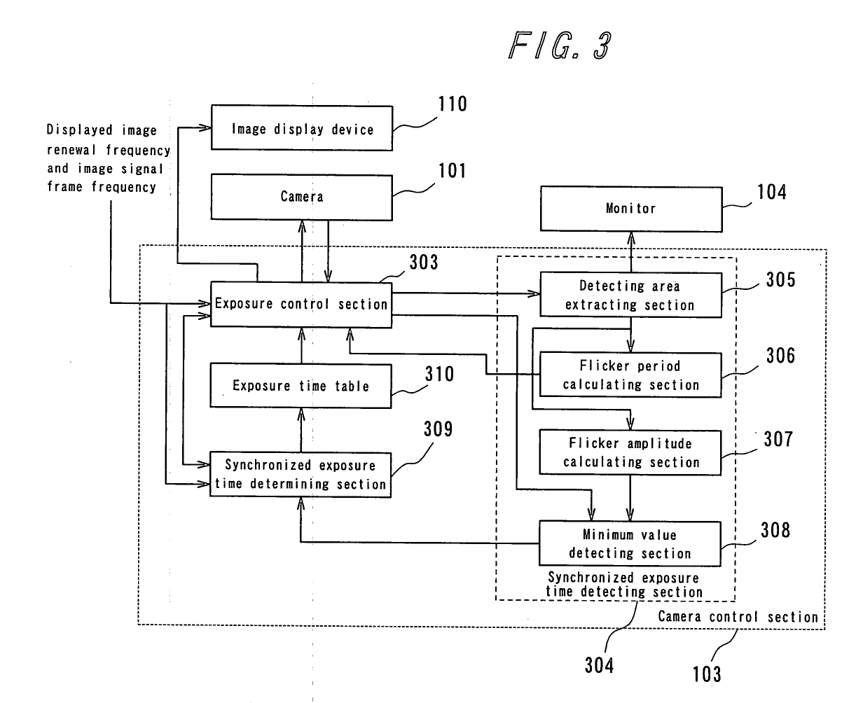

FIG. 3 is a block diagram showing the arrangement and function of the camera control section 103 shown in FIG. 1. The camera control section 103 serves to control the camera 103 so as to capture a test pattern displayed on the image display device 110, as required by the calibration data calculating section 105. The camera control section 103 includes a capturing control means in the form of a capturing control section 303, a synchronized exposure time detecting section 304, a flickerless exposure time calculating section in the form of a synchronized exposure time determining section 309, and an exposure time table 310. Furthermore, the synchronized exposure time determining section 304 includes a detecting area extracting section 305, a flicker period calculating means in the form of a flicker period calculating section 306, a flicker amplitude calculating means in the form of a flicker amplitude calculating section 306, and a minimum value detecting section 308.

First of all, in order to stably capture the test pattern displayed by the image display device 110, there is prepared a table of exposure times in which flickers corresponding to the image renewal frequency of the image display device 110 do not occur.

To this end, if the image renewal frequency of the image display device is known, this information is input into the computer 102 by a calibration operator and thereby input into the exposure control section 303 of the camera control section 103.

Subsequently, the exposure control section 303 generates a command to the image display device 110to display a single primary color image (e.g., red color image) with a uniform luminance so that such an image is displayed. Incidentally, instead of a single primary color image with a uniform luminance, there may be displayed any test pattern which does not change with time, and of which the luminance level is not less than a predetermined value.

Furthermore, the exposure control section 303 sets search ranges of the exposure time of the camera 101 for capturing the image. Assuming that the image renewal frequency for the image display device 110 is α Hz (or, in the case of a single panel type projector with a color wheel including N color filters, the image renewal frequency is defined as rotational frequency of the wheel multiplied by N), the search range of the exposure time [Tshort (n), Tlong (n)] is obtained with respect to three ranges, as Tshort (n)=(n−γ)/α and Tlong (n)=(n+γ)/α, where n is 1, 2, 3, and γ is a coefficient for adjusting the search range, expressed as 0 <γ≦0.5.

On the contrary, if the image renewal frequency α Hz is unknown, it is assumed that α=60 Hz, for example, to set the ranges of the exposure time. In this instance, it is further assumed, for example, that Tshort=0.5/α and Tlong=3.5/α, so as to set a range in which at least three synchronized exposure times can be searched.

The searched exposure time within the synchronized exposure time search range [Tshort (n), Tlong (n)] in the case of known image renewal frequency, or the searched exposure time within the range [Tshort, Tlong] in the case of unknown image renewal frequency, is set to be M times the minimum time that can be exposure-controlled with respect to the camera 101 itself, where M is an integer of a value predetermined in view of the detecting accuracy of the synchronized exposure time to be calculated, and the time length required for the calculation.

Subsequently, a single color image with a uniform luminance, which is being displayed, is captured by the camera 101 and the position of the turret 204 is determined to select one of the ND filters 208, 209 or the through hole 210, which becomes close to the exposure time Tlong (n) under the condition that the maximum value of the average luminance levels in an 8×8 image blocks, for example, of the captured image is within a predetermined tone level range.

On this occasion, if the aperture of the capturing lens 203 can be automatically controlled, the adjustment may be made inclusive of the aperture control. Furthermore, if the adjustment cannot be made with these changeover, a command for changing the luminance level is sent to the image display device 110.

As for further details of the processing, the exposure control section 303 causes the capturing to be performed based on a selectable exposure time at an initial state of the camera 101 (i.e., based on the exposure time table, not shown, which is stored in the exposure control section 303 ), judges whether the maximum value in the displayed area of the captured image is within the predetermined tone level range and, if the maximum value is outside of the range, performs changeover of the ND filters 208, 209 or the like and the luminance level control of the image display device 110. In this way, the initial state for detecting the synchronized exposure time is determined.

Subsequently, the exposure control section 303 causes the camera 101 to perform capturing a predetermined number of times with an exposure time Tlong (n) so as to determine the flicker period, and the captured images are outputted to the synchronized exposure time detecting section 304. Incidentally, the number of time of capturing is determined based on the upper limit value of the flicker period to be detected.

With reference to the captured images inputted to the synchronized exposure time detecting section 304, the captured image within a predetermined detecting area is extracted by the detected area extraction section 305, and the extracted captured image corresponding to the detecting area is inputted to the flicker period calculating section 306.

The flicker period calculating section 306 serves to calculate the average luminance values of the pixels within the detecting area of the successive captured images, and store these values in chronological order in order to calculate the capturing period based on the maximal values and/or minimal values. The capturing period so calculated is outputted to the exposure control section 303, as the flicker period.

According to the illustrated embodiment, since two projectors 107, 108 are driven as being synchronized by the external synchronizing means, the flicker period is calculated based on the maximal values and/or minimal values of the average luminance values of the pixels within the detecting area, assuming that the flickers within the detecting area are the same in phase. Thus, if three successive extremal values including the maximal value and the minimal value are detected within the period of the predetermined number of times of capturing, the period between the two maximal values or the two minimal values is determined as the flicker period. If only two extremal values in the form of a maximal value and a minimal values are detected, twice the period between these extremal values is determined as the flicker period. If only one extremal value in the form of a maximal value or a minimal value is detected, twice the above-mentioned predetermined number of times is determined as the flicker period.

In the exposure control section 303, based on the flicker period as calculated by the flicker period calculating section 306, the number of times of capturing with the same exposure time for calculating the flicker amplitude is set to be flicker period+1. Thus, since the shortest flicker period is twice the capturing period, this number of times of capturing is not less than 3.

Subsequently, in order to calculate the flicker amplitude, capturing is performed with an exposure time Tj that is sampled with a predetermined interval D within the synchronized exposure time search range [Tshort (3), Tlong (3)] decided as mentioned above, from Tlong (3) toward Tshort (3), where D=(M×minimum exposure-controllable time), j=1˜ L, L being the number of sampling within a period from T1=Tlong (3) to TL=Tshort (3).

As for the processing to this end, the exposure control section 303 sets, with respect to the camera 101, a designated exposure time within the synchronized exposure time search range so that capturing by the camera 101 is performed the predetermined number of times as decided by the above-mentioned flicker period. The captured images are inputted from the exposure control section 303 into the detection area extraction section 305, and the detection area as extracted at the detection area extraction section 305 is inputted to the flicker amplitude calculating section 307.

At the flicker amplitude calculating section 307, the maximum temporal deviation of the detecting area corresponding to the number of times of capturing as determined by the flicker period is calculated, and such maximum deviation is outputted to the minimum value detecting section 308 as the flicker amplitude.

To the flicker amplitude calculating section 307, a capturing exposure time upon calculation of the flicker amplitude is further inputted from the exposure control section 303, so that such exposure time is stored in a memory, not shown, as being correlated with the flicker amplitude.

After the above-mentioned processing has been performed with respect to the entirety of the synchronized exposure time search range [Tshort (3), Tlong (3)], the minimum value is searched among the flicker amplitudes stored at the minimum value detection section 308, and the exposure time corresponding to the detected minimum time is outputted to the synchronized exposure time determining section 309 as synchronized exposure time candidate Tsync3. With respect to the remaining two synchronized exposure time search ranges [Tshort (2), Tlong (2)] and [Tshort (1), Tlong (1)], the synchronized exposure time candidates Tsync2 and Tsync1 are determined in the same manner and outputted to the synchronized exposure time determining section 309.

The synchronized exposure time determining section 309 serves to determine the synchronized exposure time interval βm based on a linear relationship between the synchronized exposure time and the synchronizing number, and using the synchronized exposure time candidates Tsynch1, Tsync2 and Tsync1 and the flicker amplitudes corresponding thereto, to calculate the certainty factor level of the synchronized exposure time interval βm, and to determine whether or not to use the synchronized exposure time interval βm depending upon the certainty factor level thereof. The details of calculation of the synchronized exposure time interval βm and certainty factor level thereof will be explained hereinafter.

The result of determination at the synchronized exposure time determining section 309 based on the certainty factor level is outputted to the exposure control section 303. At the same time, if the certainty factor level is judged to be high, the exposure time of βm×N is outputted to the exposure time table 310, where N is such an integer of not less than 1 that βm×N does not exceed the longest exposure time of the camera 101 as its hardware specification. On the other hand, if the certainty factor level is judged to be low, nothing is outputted to the exposure time table 310.

At the exposure control section 303, if the result of determination that the certainty factor level is low is inputted from the synchronized exposure time determining section 309, the process is repeated wherein the above-mentioned image changeover frequency is halved to reset the search range [Tshort (n), Tlong (n)] so as to calculate the number of times of capturing and the flicker amplitude, and thereby determine three new synchronized exposure time candidates. Such a process is repeated until the image changeover frequency becomes the frame frequency of the image signal. If a sufficient certainty factor level cannot be still obtained, the exposure time table is formed by determining the reciprocal of the frame frequency of the image signal to be the synchronized exposure time interval βm. In this way, even if a synchronized exposure time with a sufficient accuracy cannot be obtained, the possibility of suppressing the flicker can be enhanced as compared to the case wherein the exposure time can be selected unlimitedly.

With the above-mentioned processing, the setting of the synchronized exposure time for the camera 111 to capture the test pattern image displayed on the image display device 110 is completed. Subsequently, the optimum exposure time is determined by the exposure control section 303 with the selectable synchronized exposure time stored in the exposure time table 310, the test pattern image is captured by the camera 111 with the optimum exposure time determined as above, and the captured image is inputted to the calibration data calculation section 105.

At the calibration data calculation section 105, based on the captured image inputted from the camera 101, such calibration data is calculated, which allows the image display device 110 to display the optimum image, and the calculated calibration data is inputted to the displayed image processing device 106. By this, at the displayed image processing device 106, image processing is performed based on the calibration data, to carry out the geometrical calibration and color calibration of the inputted external image signal which is then inputted to the projectors 107, 108.

Incidentally, the detecting area upon calculation of the above-mentioned synchronized exposure time mat be the entire displayed area of the screen 109 among the captured image, though it is preferably only a part of the displayed area in order to shorten the processing time.

Further details of the synchronized exposure time detecting section 304 will be explained below.

The synchronized exposure time detecting section 304, as mentioned above, includes the detecting area extraction section 305, the flicker period calculating section 306, the flicker amplitude calculating section 307 and the minimum value detecting section 308.

The captured image over the exposure time Tj inputted to the synchronized exposure time detecting section 304 is inputted to the detecting area extraction section 305. At the detecting area extraction section 305, the detecting area is extracted by either one of the manual mode for allowing a manual selection, by an operator, of the detecting area of a predetermined size, and an automatic mode for automatically extracting the detecting area from the inputted captured image based on the difference in tone between the displayed area of the displayed image and the peripheral area, and such a detecting area is outputted to the flicker period calculating section 306 or the flicker amplitude calculating section 307.

The flicker period calculating section 306 calculates the pixel average value Σxyfn(x, y)/Nxy of the predetermined detecting area (where Σxy is the sum of x=1˜Nx, y=1˜Ny, and Nxy=Nx×Ny), and holds its chronological change so as to determine the flicker period Fp which is the minimum distance of the three extremal values in total, including the maximal value and the minimal value.

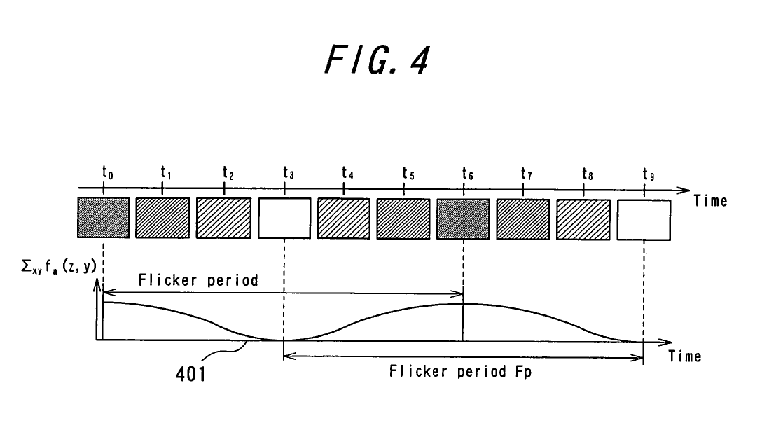

FIG. 4 shows the relationship between the flicker period and the pixel average value Σxyfn(x, y)/Nxy, wherein the change in luminance of the detecting area obtained at the capturing timings from time t0 to time t9 is indicated by a hatched rectangle, and the corresponding relationship between the pixel average value and time is indicated by a graph 401. The flicker period is the period between a maximal value and a next maximal value, or between a minimal value and a next minimal value. In this instance, the number of sample positions tn satisfying a first set of conditions Σxy{fn(x, y)−fn−1(x, y)}≧0 and Σxy{fn(x, y)−fn+1(x, y)}≦0, as well as the number of sample positions tn satisfying a second set of conditions Σxy{fn(x, y)−fn−1(x, y)}≦0 and Σxy{fn(x, y)−fn+1(x, y)}≦0, are searched beginning from n=1. Such search process is ended at a time point when two sample positions satisfying one set of conditions and one sample position satisfying the other set of conditions have been found.

At the flicker amplitude calculating section 307, the maximum deviation of the average luminance level for (flicker period+1) times, as calculated with respect to the above-mentioned predetermined detecting area of the images captured with an exposure time Tj.

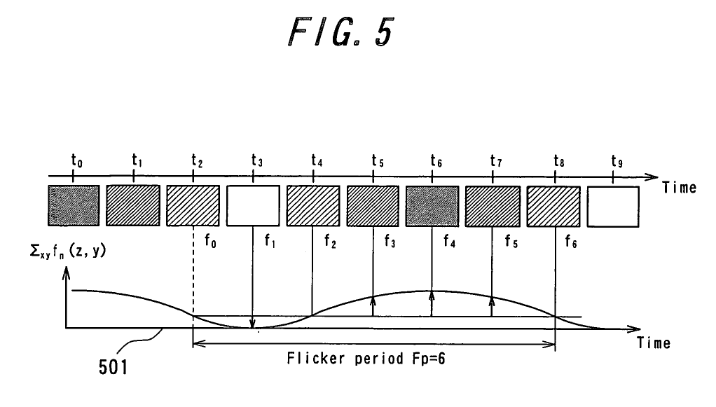

FIG. 5 is a view explaining the above-mentioned flicker amplitude, wherein hatched rectangles f0 to f6 indicate the detecting areas captured over one flicker interval from time t0 to time t6, and the graph 501 shows the relationship between the pixel average value Σxyfn(x, y)/Nxy of the detecting area and time. In this case, the flicker amplitude Fa(Tj) is defined as:

$$Fa ( Tj ) = MAX [ \sum x y \{ fn ( x , y ) - f 0 ( x , y ) \} / Nxy ; n = 1 , … , Fp ] - MIN [ \sum xy \{ fn ( x , y ) - f 0 ( x , y ) \} / Nxy ; n = 1 , … , Fp ]$$

Here, the symbol “MAX [ ]” indicates the maxim value among the average values Σxy{fn(x, y)−f0 (x, y)}/Nxy; n=1, . . . , Fp of the inter-frame differences, and the symbol “MIN [ ]” indicates the minimum value among the average values Σxy{fn(x, y)−f0 (x, y)}/Nxy; n=1, . . . , Fp of the inter-frame differences.

The minimum vale detecting section 308 includes a memory, not shown, for holding the flicker amplitude Fa(Tj) at an exposure time Tj with respect to the three synchronized exposure time search ranges [Tshort (n), Tlong (n)] (n=1, 2, 3) in case the image renewal frequency is known. In this instance, at a point in time when all the flicker amplitudes at a designated exposure time within each search range, as calculated by the flicker amplitude calculating section 307, are held by the memory, the minimum value detecting section 308 serves to search one exposure time for each search range, with which the flicker amplitude becomes the minimum.

Furthermore, when the image renewal frequency is unknown, the flicker amplitude Fa(Tj) at the exposure time Tj with respect to the synchronized exposure time search range [Tshort, Tlong] is held by the memory, and three exposure times, with which the flicker amplitude becomes the minimal, are searched at a point in time when all the flicker amplitudes at a designated exposure time within each search range, as calculated by the flicker amplitude calculating section 307, are held by the memory.

When the minimum and minimal values of the flicker amplitude are searched, on order to avoid confusion of an incorrect position with the minimum or minimal value due to the variation of intra-image noise upon capturing, there may be used, instead of the flicker amplitude Fa(Tj), per se, a flicker amplitude FaL(Tj) which has been obtained by low-pass filtering of any tap number, such as FaL(Tj)={Fa(Tj−1)+Fa(Tj)+Fa(Tj+1)}/3. Also, in order to calculate a sub-sample position which is narrower than the sampling exposure time interval, an interpolating calculation may be performed using a plurality of flicker amplitude values around the minimum value (or the minimal value).

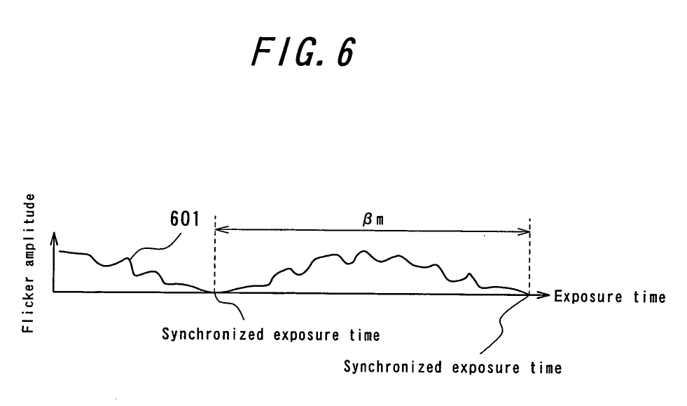

In case the image renewal frequency is unknown, when three exposure times, with which the flicker amplitude becomes the minimal, are to be searched within the search range [Tshort, Tlong], there would be no problem if the flicker amplitude FaL(Tj) exhibits gradual decrease or increase with time and the point where the differential is zero and the flicker amplitude is convex downwards (i.e., minimal) appears only at the desired three exposure times. However, if, as shown by the graph 601 in FIG. 6, the relationship between the flicker amplitude and time is locally changing to exhibit a number of minimal values, the exposure time is searched by a method explained below.

First of all, the maxmin ratio [Ti;Tj] is defined as (FaLmax [Ti;Tj]−FaLmin [Ti;Tj])/(FaLmax [Ti;Tj]+FaLmin [Ti;Tj]), and the maxmin ratio [Ti;Tj] is determined, for example, from the position Ti=Tlong to the position Tj within the search range. Here, FaLmax [Ti;Tj] is the maximum value of the flicker amplitude from the starting point Ti to the current search point Tj, and FaLmin [Ti;Tj] is the minimum value of the flicker amplitude from the starting point Ti to the current search point Tj.

If, at a position Tj=Tk, the maxmin ratio [Ti;Tk] exceeds a predetermined threshold value, the position where the flicker amplitude assumes the minimum value is determined to be the desired minimal value, in the interval [Tk;Tl] up to the point Tj=Tl where, after changing the starting point as Ti=Tk, the maxmin ratio [Tk;Tj] exceeds the predetermined threshold value again. At a point in time when this minimal value is determined, the starting position of the maxmin ratio [Ti;Tj] is changed as Ti=Tl, and a similar processing is performed to obtain three minimal values in total. In this way, it is possible to sufficiently suppress erroneous detection of the minimal values.

The exposure times for the searched three minimum (or minimal) flicker amplitudes are outputted to the synchronized exposure time determining section 309, as the synchronized exposure time candidates Tsync1, Tsync2 and Tsync3. Furthermore, the maximum flicker amplitude value within a predetermined range around the synchronized exposure time candidates Tsync1, Tsync2 and Tsync3 is also outputted to the synchronized exposure time determining section 309.

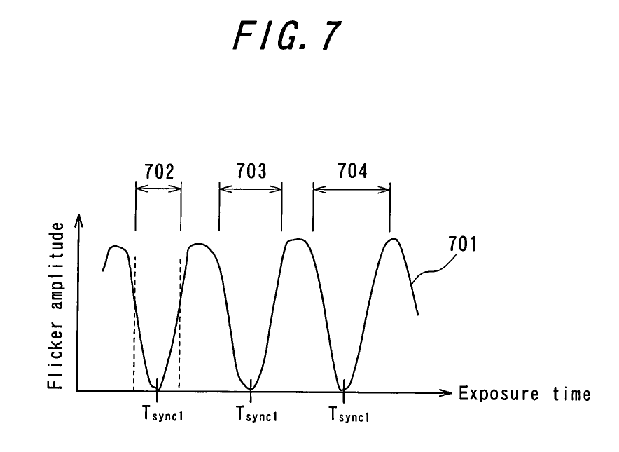

FIG. 7 is a graph showing the relationship between the exposure time and the flicker amplitude. In the graph 701 depicted in FIG. 7, the synchronized exposure time search ranges [Tshort (n), Tlong (n)] (n=1, 2, 3) correspond, respectively, to 702, 703 and 704, and the positions of the minimum value in each range correspond, respectively, to the synchronized exposure time candidates Tsync1, Tsync2 and Tsync3.

Here, the synchronized exposure time search range 704 is the widest, and the ranges 703, 702 are progressively narrower for the following reason. Namely, since it is not readily possible to estimate with high accuracy at what position of the synchronized exposure time search range 704 to be searched first the minimum value exists, the search range is set to be a wide range of ±0.4β, for example. With the so-obtained synchronized exposure time candidate Tsync3, even if the synchronized exposure time search range 704 to be next searched is made narrower, such as ±0.3β around Tsync3 ×2/3, it becomes possible to sufficiently detect the minimum value. Furthermore, the successive synchronized exposure time search range 302 can be made still narrower, based on the two synchronized exposure time candidates Tsync3 and Tsync2, as ±0.2β around (Tsync3/3+Tsync2/2)/2. In this way, it is possible to shorten the searching time, as compared to the case in which the three search ranges are made the same.

At the synchronized exposure time determining section 309, an optimum gradient βm is determined based on a linear relationship between the synchronized exposure time and synchronizing number, and this gradient βm is defined as the shortest synchronized exposure time.

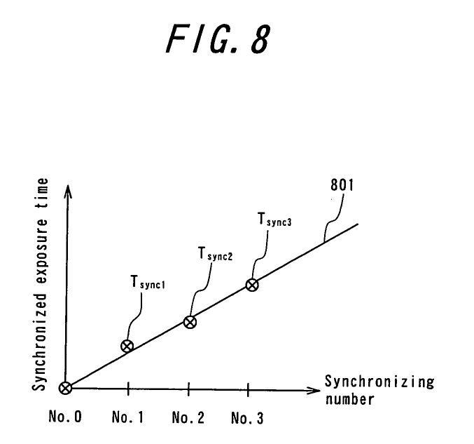

Namely, with reference to FIG. 8, based on a condition that the synchronized exposure time exists on a straight line 801 passing the origin (where Tsync=0 and the flicker does not occur), and using the three synchronized exposure time candidates Tsync1, Tsync2, Tsync3 and the reciprocals of the flicker amplitude values at these positions as the weights W1, W2, W3 for the synchronized exposure time candidates, the synchronized exposure time interval βm which minimizes the error E=W1(Tsync1−βm)²+W2(Tsync2−2βm)²+W3(Tsync3−3m)², as well as the correlation coefficient for such condition are calculated.

Furthermore, the maxmin ratio=(FaLmax−FaLmin)/(FaLmax+FaLmin) of the flicker amplitudes around the three synchronized exposure time candidates Tsync1, Tsync2, Tsync3 are calculated, respectively, and the minimum value of the calculated three ratios is multiplied by the correlation coefficient to define the certainty factor level. If this certainty factor level is not less than a predetermined threshold value, the result of calculation is assumed to be correct, and thus outputted to the exposure control section 303, and the exposure time βm×N is stored in the exposure time table 310, where N is such an integer of not less than 1 that βm×N does not exceed the longest exposure time of the camera 101 as its hardware specification.

On the other hand, if the certainty factor level is less than the predetermined threshold value, provided that the image renewal frequency corresponding to the current synchronized exposure time search range is not less than twice the frame frequency of the image signal, a status signal is outputted to the exposure control section 303 to indicate that the result of calculation is erroneous, thereby demanding change of the synchronized exposure time search range with the image renewal frequency halved. Furthermore, if the halved image renewal frequency is the same, or substantially same as the frame frequency of the image signal, a status signal indicating that the exposure time table has a poor accuracy is outputted to the exposure control section 303, and the exposure time table 310 is renewed by the exposure time βm×N, where βm is the reciprocal of the frame frequency of the image signal. In the case of the poor accuracy of the exposure time table, the number of times of repeated capturing of the test pattern image to be used in the data calculating section is increased to obtain an average value, to thereby mitigate the influence of possible flickers.

In the above explanation, the synchronized exposure time interval βm is calculated based on the three synchronized exposure time candidates Tsync1, Tsync2 and Tsync3, though it is needless to mention that the synchronized exposure time interval βm can be calculated if at least two synchronized exposure time candidates Tsync1 and Tsync2 are available, and further that highly accurate synchronized exposure time interval βm can be obtained if the detecting accuracy of the synchronized exposure time candidates is sufficiently high. Moreover, even if the detecting accuracy of the synchronized exposure time candidates is not sufficiently high, a highly accurate synchronized exposure time interval βm can be obtained by using a number of, or at least three synchronized exposure time candidates. In this instance, however, the detection requires a longer time so that the number of the synchronized exposure time candidates is determined depending upon the required accuracy of calculation.

### Second Embodiment

A second embodiment of the present invention will be described below, wherein the two projectors 107, 108 are driven synchronously with each other by an internal synchronizing means, instead of an external synchronizing means as in the first embodiment. The following explanation is focused on the manner of calculating the flicker period and flicker amplitude.

In the case of multi-projectors operating with an internal synchronizing means, the displayed images are generally out of phase and the image renewal frequency tends to fluctuate due to individual differences. Therefore, if the displayed images of the multi-projectors are captured at once, it would be necessary to determine the synchronized exposure time that is optimum to the multi-projectors.

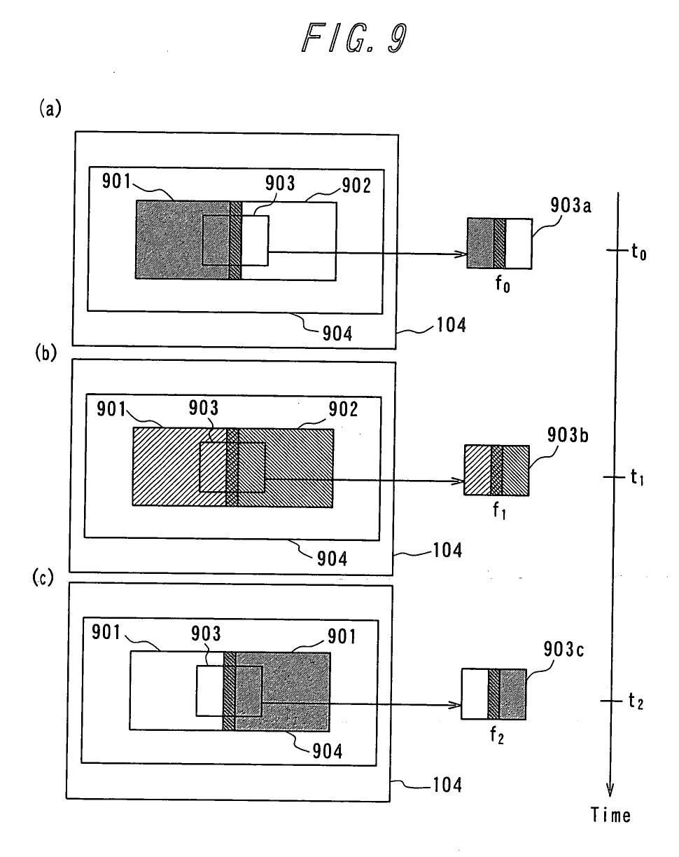

Schematically illustrated in FIGS. 9(a) to 9(c) is the capturing status of the images projected by two projectors which are operating synchronously with an internal synchronizing means. As shown in FIGS. 9(a) to 9(c), the monitor 104 displays the area 904 of the screen 109 chronologically captured by the camera 101, as well as the display areas 901, 902 of the projectors 107, 108 within the area 904. Here, FIG. 9(a) shows the image 903a at a time t0, FIG. 9(b) shows the image 903b at a time t1, and FIG. 9(c) shows the image 903c at a time t2.

It will be appreciated from FIGS. 9(a) to 9(c) that if an area including an overlapping region of the two display areas 901, 902 is designated as the detecting area 903 of the flicker period and the flicker amplitude, their change within the detecting area 903 at times to, t1, t2 is not uniform as shown at f0(903a), f1(903b), f2(903c), thereby giving rise to a local difference in the luminance, with the flicker phase differing depending upon the location.

Accordingly, with the captured image of such a state, it is difficult to calculate the flicker period and the flicker amplitude by the method explained with reference to the first embodiment. This is because the processing for averaging is used to averaging of the luminance within the area, so that the chronological change cannot be extracted.

Thus, in the second embodiment, the flicker period is redefined as follows. Namely, with reference to the captured image f0 of the detecting area at time t0, there is calculated an average value ΣxyABS{fn(x,y)−f0(x,y)}/Nxy of the pixel absolute values of the differential images of the captured images f1, f2, . . . at times t1, t2, . . . , where ABS { } means the absolute value, N is an integer of not less than 1, Σxy is the sum of x=1˜Nx, y=1˜Ny, and Nxy=Nx×Ny. Furthermore, the chronological change of the average value calculated as above is held and used as the distance of the desired three extremal values in total, including the maximal and minimal values.

With respect to the definition of the flicker amplitude FaN(Tj), as is the case with the calculation of the flicker period FpN, there is used an average value of the pixel absolute values of the differential images so as to allow detection of the flicker amplitude from the following formula, even if the flicker phase is different in the detecting area.

$$FaN ( Tj ) = MAX [ \sum xy ABS \{ fn ( x , y ) - f 0 ( x , y ) \} / Nxy ; n = 1 , … FpN ] - MIN [ \sum xy ABS \{ fn ( x , y ) - f 0 ( x , y ) \} / Nxy ; n = 1 , … FpN ]$$

It is needless to mention that the absolute value averaging section may be replaced by an average of the differences to an even power, such as an average of the square values of the differences.

In this instance, the relationship between the flicker amplitude FaN(Tj) and the exposure time is as shown by the graph 601 in FIG. 6. Namely, since the flicker amplitude FaN(Tj) is determined based on the absolute values of the inter-frame differentials with reference to the initially captured image, there may be included a number of minimal values which change locally, depending upon the capturing timing, from the original amplitude value by a half of the amplitude value. However, even in such a situation, the minimal values in the synchronized exposure time can be deemed to be zero if capturing noise or fluctuation in the light source of the projector is neglected. Thus, it is possible to obtain one minimum value of the flicker amplitude FaN(Tj) from the search range, and set the position of this minimum value as the synchronized exposure time.

When a plurality (three) of the desired, probable minimal values are obtained from the graph 601 including a number of minimal values, the method explained with reference to the first embodiment may be used, wherein one minimum value is obtained for an interval determined based on the maxmin ratio [Ti;Tj] and the threshold value. Here, the determination method starts with a sufficiently large value as the initial value of the threshold value, and repeats the detection by decreasing the threshold value until a desired number of the minimal values are obtained.

Furthermore, the average value ΣxyABS{fn(x,y)−f0(x,y)}/Nxy of the pixel absolute values of the differential images as used for the calculation of the flicker period also exhibits s graph shape including a number of local minimal values similar to the graph of FIG. 6. In this instance, the desired two minimal values for the calculation of the flicker period can be calculated as in the above-mentioned manner, wherein one minimum value is obtained for an interval determined based on the maxmin ratio [Ti;Tj] and the threshold value.

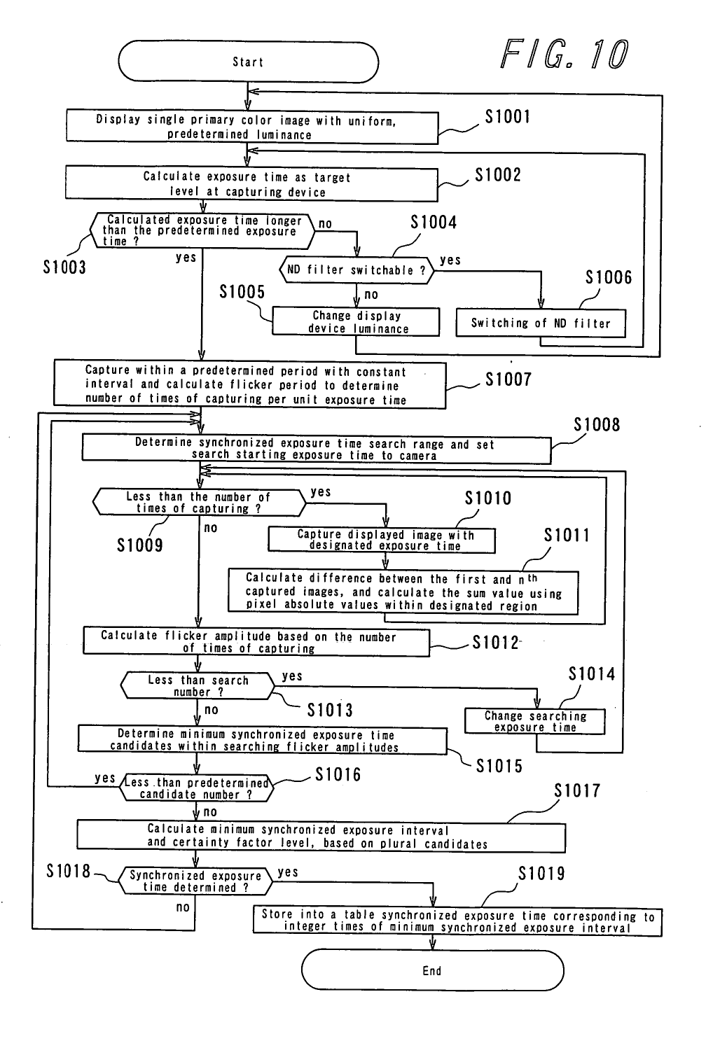

FIG. 10 is a flowchart showing the process for determining the synchronized exposure time in a multi-projection system.

By starting the synchronized exposure time calculation process, first of all, a single color image with uniform, predetermined luminance is displayed by the image display device 101 (step S1001), the exposure time as target tone level at the capturing device is then calculated (step S1002), and judgment is made as to whether the calculated exposure time is longer than the predetermined exposure time (stem S1003).

In this instance, if the calculated exposure time is judged to be less than the predetermined exposure time, judgment is made as to whether the ND filter provided for the image capturing device 111 can be switched (stem S1004). If it is judged that the ND filter can be switched, the ND filter is switched (step S 1006 ), and the process is returned to the step S1002. If it is judged that the ND filter cannot be switched, the luminance level of the image display device is lowered (step S1005 ) and the process is returned to the step S1001.

On the other hand, if the calculated exposure time is judged to be not less than the predetermined exposure time, capturing is performed within a predetermined period with a constant time interval so as to calculate the flicker period, and the number of times of capturing per unit exposure time for calculating the flicker amplitude is determined.

Subsequently, the synchronized exposure time search range (search starting exposure time, interval and number) is determined based on the image renewal frequency of the image display device, the exposure time for the first search is set to the camera (stem S1008 ), and judgment is made as to whether the number of times of capturing within the exposure time, which has been set to the camera, is less than the number of times of capturing determined by the flicker period (step S1009 ).

In this instance, if it is judged that the number of times of capturing has not yet been reached, the displayed image is captured with the set exposure time (step S1010 ), the difference between the first captured image and n^{th} captured image to obtain the absolute values of the pixels within a designated area, and the sum of such absolute values is calculated (step S1012).

On the other hand, if it is judged that the number of times of capturing has been reached, the flicker amplitude over a unit exposure time is calculated based on the sum value as calculated in the step S1011 (step S1012).

Subsequently, it is judged as to whether the calculation of all the flicker amplitudes with respect to the searching exposure time has been completed (step S1013). If it is judged that the calculation of all the flicker amplitudes has not yet been completed, the searching exposure time is changed (step S1014) and the process is returned to the step S1009. If the calculation of all the flicker amplitudes with respect to the searching exposure time has been completed, synchronized exposure time candidates corresponding to the minimum flicker amplitude over the searching exposure time are determined (step S1015), and it is further judged as to whether determination of a predetermined number (e.g., three) of synchronized exposure time candidates has been determined (step S1016).

In this instance, if the number of synchronized exposure time candidates has not yet reached the predetermined number, the process is returned to the step S1008. On the other hand, if the number of synchronized exposure time candidates has reached the predetermined number, the minimum interval βm of the synchronized exposure time and its certainty factor level are calculated based on the synchronized exposure time candidates. If the calculated certainty factor level is less than a predetermined threshold value, and the error between the integer times the minimum interval βm of the synchronized exposure time and the frame period of the image is not less than a predetermined threshold value, it is judged that the synchronized exposure time has not been determined so that the process is returned to the step S1008.

On the other hand, if it is judged that the calculated certainty factor level is not less than the predetermined threshold value, or if the error between the integer times the minimum interval βm of the synchronized exposure time and the frame period of the image is less than the predetermined threshold value, it is assumed that the synchronized exposure time has been determined. Thus, the synchronized exposure time with the minimum interval βm×N (N is an integer of not less than 1) is stored in the exposure time table (step S1019) to complete the process for calculation of the synchronized exposure time.

If the synchronized exposure time is determined in accordance with the above-mentioned first embodiment, it is possible to use in the step 1011 the differences in pixels within the designated area between the first captured image and the nth captured image, and calculate the sum of such differences.

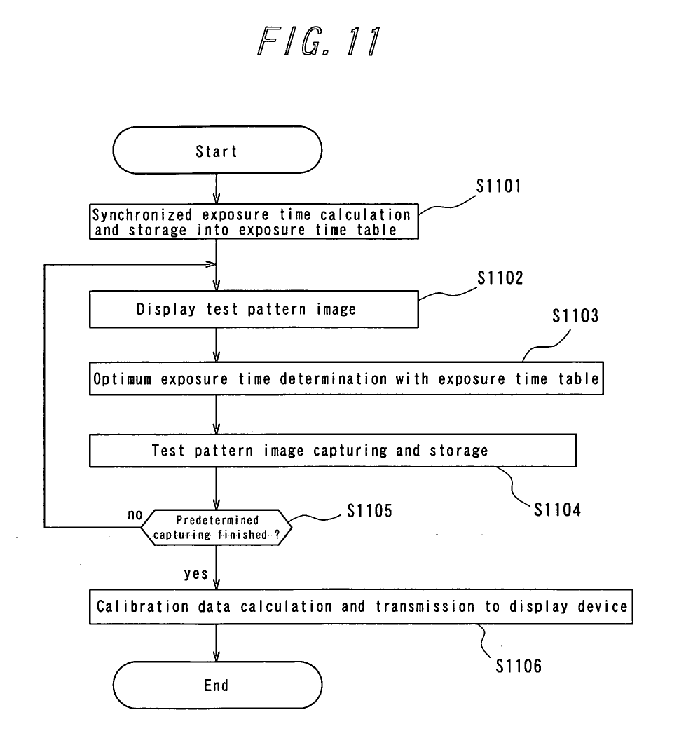

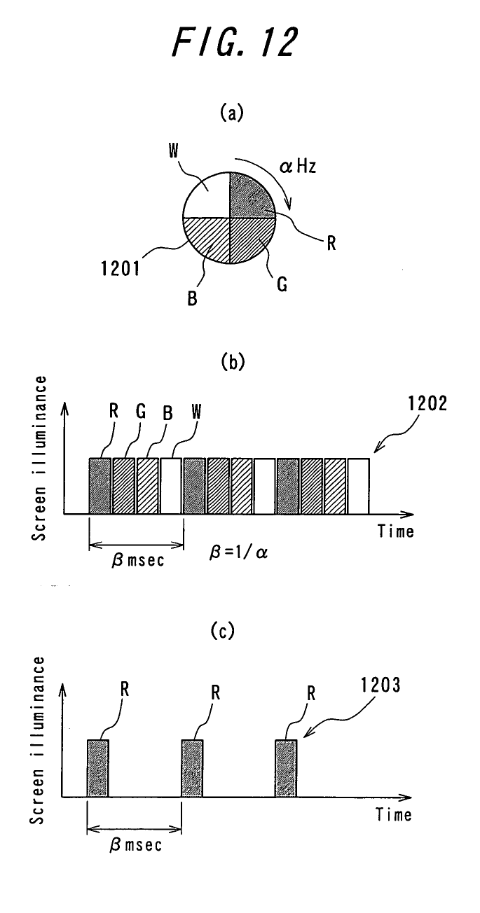

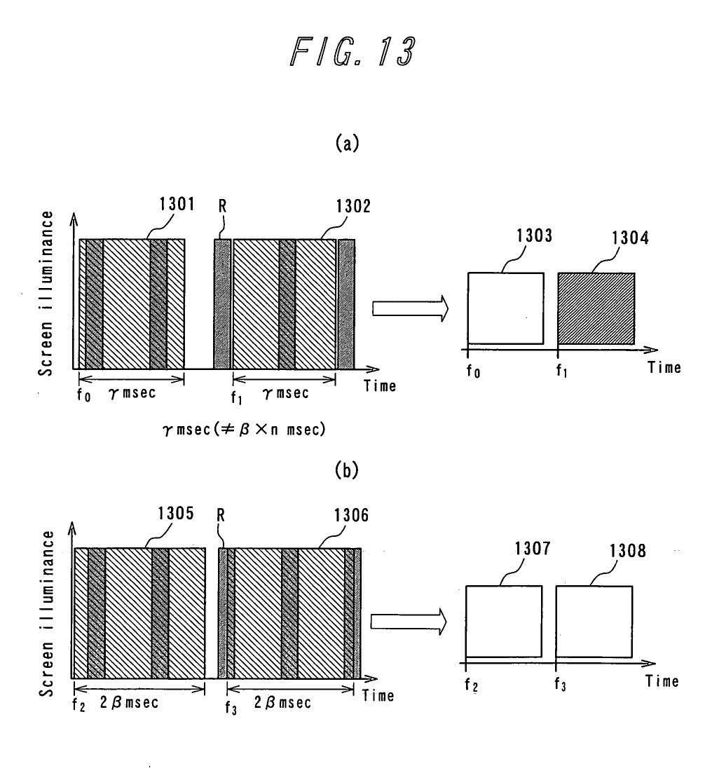

FIG. 11 is a flowchart showing the process for obtaining calibration data in a multi-projection system embodying the present invention.

First of all, before capturing of the test pattern image, the synchronized exposure time applicable to the image capturing device 111 with reference to the image display device 110 is calculated and stored in the exposure time table (step S1101).

Subsequently, capturing of the test pattern image is performed by displaying the test pattern image (step S1102), using the synchronized exposure time, which has been stored in the exposure time table in the step S1101, for selecting the optimum exposure time with reference to the displayed test pattern (step S1103), and capturing the test pattern image with the selected exposure time and storing the captured image into a file (step S1104).

Then, a judgment is made as to whether all the test pattern images for calculating the calibration data have been captured (step S1105). If it is judged that the test pattern images to be captured are still remaining, the process is returned to the step S1102 to display the remaining test pattern images which have not yet been captured, and repeat the capturing. If it is judged that the capturing of all the test pattern images has been completed, the calibration data is calculated based on the captured images stored in the file, and the calculated data is transmitted to the displayed image processing device (step S1106), so as to complete the calibration.

In the above-mentioned first embodiment of the present invention also, it is possible to obtain the calibration data with the process shown in FIG. 11.

According to the first and second embodiments of the present invention explained above, when the displayed image of the image display device 110 is captured by a capturing device adopting a global shutter system, such as a CCD device, it is possible to highly accurately calculate the synchronized exposure time which does not cause occurrence of flickers without using a synchronizing signal. Therefore, it is possible to arrange the capturing device 111 for capturing test pattern images as the basis for calculating calibration data for a large scale image display device 110 such as a multi-projection system, at a desired location, without being limited by a physical cable length. The degree of freedom in the arrangement of the image capturing device can be further enhanced by a wireless communication, instead of a wired connection.

The present invention has been described above with reference to certain preferred embodiments of the present invention. However, it is needless to mention that various changes may be made without departing from the scope of the invention as defined by the appended claims.

Thus, for example, while the illustrated embodiments have been explained with reference to a multi-projection system, the present invention can also be similarly applied also to a single display device, such as an LCD monitor of a personal computer, so as to capture the displayed images without flickers. Moreover, the present invention can also be applied to a CMOS capturing device, provided that is adopts a global shutter system.

Furthermore, upon calculation of the flicker amplitude, the first embodiment uses a method in which an average value of the sum of the differences in pixels in the predetermined area between the first captured image and the n^{h} captured image. However, the flicker amplitude may be calculated using the sum of the differences in pixels, without calculating the average value. Similarly, the second embodiment uses a method in which the flicker amplitude is calculated using an average of the sum of the absolute values of the differences in pixels in the predetermined area between the first captured image and the n^{th} captured image. However, the flicker amplitude may be calculated using the sum of the absolute values of the differences in pixels, without calculating the average value.

1. A displayed image capturing method for capturing displayed images by a global-shutter type image capturing device, said displayed images being periodically displayed on an image display device, comprising:
displaying, prior to actual capturing of said displayed images, a predetermined image on said image display device and capturing said predetermined image N-times (N>2) by said image capturing device with a predetermined capturing period, and over an exposure time selected from a predetermined search range, so as to obtain N captured images;
calculating, among said N captured images, N−1 sum values or average values of differences between a specified image and remaining images at their predetermined regions, and obtaining a flicker amplitude evaluation value based on a deviation of said sum values or of said average values;
calculating a flickerless exposure time based on at least two exposure times which are minimal values among said flicker amplitude evaluation values corresponding to a plurality of exposure times within said search range; and
subsequently controlling the exposure time of said image capturing device based on the calculated flickerless exposure time, so as to actually capture the displayed image of said image display device.

2. The displayed image capturing method according to claim 1, further comprising: capturing said predetermined image M-times (M>2) within a predetermined period determined by said predetermined capturing period; calculating a time variation period of an average luminance at a predetermined region of the M captured images; and calculating the number of times N of capturing said predetermined image based on said time variation period of the average luminance.

3. A displayed image capturing method for capturing displayed images by a global-shutter type image capturing device, said displayed images being periodically displayed on an image display device, comprising:
displaying, prior to actual capturing of said displayed images, a predetermined image on said image display device and capturing said predetermined image N-times (N>2) by said image capturing device with a predetermined capturing period, and over an exposure time selected from a predetermined search range, so as to obtain N captured images;
calculating, among said N captured images, N−1 sum values or average values of absolute values of differences between a specified image and remaining images at a predetermined region, or N−1 sum values or average values of said differences to an even power, and obtaining a flicker amplitude evaluation value based on a deviation of said sum values or of said average values;
calculating a flickerless exposure time based on at least two exposure times which are minimal values among said flicker amplitude evaluation values corresponding to a plurality of exposure times within said search range; and
subsequently controlling the exposure time of said image capturing device based on the calculated flickerless exposure time, so as to actually capture the displayed image of said image display device.

4. The displayed image capturing method according to claim 3, further comprising: capturing said predetermined image M-times (M>2) within a predetermined period that is determined by said predetermined capturing period; calculating, among the M captured images of said predetermined image, M−1 sum values or average values of absolute values of differences between a specified image and remaining images at a predetermined region, or M−1 sum values or average values of said differences to an even power, and calculating the number of times N of capturing said predetermined image based on a time variation period of the M−1 calculated values.

5. The displayed image capturing method according to claim 1, wherein said at least two exposure times for calculating said flickerless exposure time are exposure times with which said flicker amplitude evaluation values become minimal values, and with which deviation of said flicker amplitude evaluation values becomes not lower than a predetermined threshold value, with respect to a plurality of exposure times within said search range, including said exposure times which are said minimal values.

6. A displayed image capturing system for capturing displayed images by a global-shutter type image capturing device, said displayed images being periodically displayed on an image display device, comprising:
capturing control means for controlling said image capturing device so as to capture a predetermined image, which is displayed on said image display device, N-times (N>2) with a predetermined capturing period, and over an exposure time selected from a predetermined search range;
flicker amplitude evaluation value calculating means for calculating a flicker amplitude evaluation value by calculating, among said N captured images, N−1 sum values or average values of differences between a specified image and remaining images at their predetermined regions, and obtaining a deviation of said sum values or of said average values as a basis for calculation of the flicker amplitude evaluation value; and
flickerless exposure time calculating means for calculating a flickerless exposure time based on at least two exposure times which are minimal values among said flicker amplitude evaluation values corresponding to a plurality of exposure times within said search range.

7. The displayed image capturing system according to claim 6, further comprising flicker period calculating means for calculating the number of times N of capturing said predetermined image based on a time variation period of an average luminance at a predetermined region of M captured images (M>2) obtained by capturing said predetermined image M-times within a predetermined period determined by said predetermined capturing period.

8. A displayed image capturing system for capturing displayed images by a global-shutter type image capturing device, said displayed images being periodically displayed on an image display device, comprising:
capturing control means for controlling said image capturing device so as to capture a predetermined image, which is displayed on said image display device, N-times (N>2) with a predetermined capturing period, and over an exposure time selected from a predetermined search range;
flicker amplitude evaluation value calculating means for calculating a flicker amplitude evaluation value by calculating, among said N captured images, N−1 sum values or average values of absolute values of differences between a specified image and remaining images at a predetermined region, or N−1 sum values or average values of said differences to an even power, and obtaining a deviation of said sum values or of said average values as a basis for calculation of the flicker amplitude evaluation value; and
flickerless exposure time calculating means for calculating a flickerless exposure time based on at least two exposure times which are minimal values among said flicker amplitude evaluation values corresponding to a plurality of exposure times within said search range.

9. The displayed image capturing system according to claim 8, further comprising flicker period calculating means for calculating the number of times N of capturing said predetermined image based on a time variation period of M−1 calculated values (M>2) obtained by capturing said predetermined image M-times within a predetermined period determined by said predetermined capturing period, and calculated, among the M captured images of said predetermined image, as M−1 sum values or average values of absolute values of differences between a specified image and remaining images at a predetermined region, or M−1 sum values or average values of said differences to an even power.

10. The displayed image capturing system according to claim 6, wherein said flickerless exposure time calculating means comprises means for determining whether or not the deviation of the flicker amplitude evaluation values within said predetermined exposure time search range, including said flicker amplitude evaluation values that become the minimal values, is not lower than a predetermined threshold value.

11. The displayed image capturing system according to claim 6, wherein said capturing control means is adapted to control the exposure time of said image capturing device based on the calculated flickerless exposure time, for actually capturing the displayed image of said image display device.

12. The displayed image capturing method according to claim 3, wherein said at least two exposure times for calculating said flickerless exposure time are exposure times with which said flicker amplitude evaluation values become minimal values, and with which deviation of said flicker amplitude evaluation values becomes not lower than a predetermined threshold value, with respect to a plurality of exposure times within said search range, including said exposure times which are said minimal values.

13. The displayed image capturing system according to claim 8, wherein said flickerless exposure time calculating means comprises means for determining whether or not the deviation of the flicker amplitude evaluation values within said predetermined exposure time search range, including said flicker amplitude evaluation values that become the minimal values, is not lower than a predetermined threshold value.

14. The displayed image capturing system according to claim 8, wherein said capturing control means is adapted to control the exposure time of said image capturing device based on the calculated flickerless exposure time, for actually capturing the displayed image of said image display device.
